(19) United States
(12) Patent Application Publication
(10) Pub. No.: US 2008/0301881 A1
(43) Pub. Date: Dec. 11, 2008

(54) Log hook

(76) Inventor: Jean-Noel Dumont, Riviere du Loup (CA)

Correspondence Address: Mila Shvartsman, P. O. Box 48652, Outremont, QC, H2V 4T9, CA

(21) Appl. No.: 11/811,206

(22) Filed: Jun. 11, 2007

(51) Int. Cl. A01G 23/099; B25F 1/00; B26B 11/00

(52) U.S. Cl. 7/161

(57) ABSTRACT

The present invention relates to a log hook with a main body in an inverted U-shape configuration forming two legs. The first leg has a handle at its distal end, and the second leg has a hook element at its distal end. There is a bridge portion formed between adjacent ends of the two legs. The bridge has cutting blades attached at a predetermined position, provided to sever branches from a tree trunk. The blades extend along the outer and/or the inner edge the bridge portion. The inner edge blade can extend continuously along the bridge portion and the first leg. Cutting blades can be attachably mounted on existing log hooks with an attachment bracket. The hook element is attachably mounted to the distal end of the second leg with a fastening element.

The present invention is related to a hook, and more particularly to a logging hook.

There is known U.S. Pat. No. 3,945,065 to Victor Dushku describing a lumbering hook having a multi-function configuration including a breaking iron for tipping a tree, a wedge for preventing a saw from binding in a particular cut tree, a hook for dragging and rolling logs and a spade for cleaning around the trunk of a tree.

There is known U.S. Pat. No. 1,710,575 to A. T. Grant describing a hand hook for managing logs and trunks of a tree provided with a body having at one end a hook portion for engaging the log and a handle to manipulate the tool.

There is also known U.S. Pat. No. 3,310,331 to H. Michaud having configuration similar to U.S. Pat. No. 1,710,331 wherein the tip of the hook portion is provided with a step facilitating easy handling of pulpwood logs.

Most logs have nuisance branches: branches that hinder the logs' loading for transport and processing. Prior to loading onto a transport truck, these branches must be removed with an axe or some other cutting tool. This is a time-consuming procedure that affects efficiency and slows down the logging process.

The lumberjack always carries one tool: the log hook. He never carries an axe, although he is the most appropriate person for removal of these nuisance branches. The present invention presents a solution to this problem.

### SUMMARY OF THE INVENTION

The present invention comprises a log hook with a main body, said main body having a substantially inverted U-shape configuration forming two legs. The first leg has a handle formed at its distal end, and the second leg has a hook element extending from its distal end. A bridge portion is formed between adjacent ends of said first and second legs. The main body is provided with a branch removal means attached at a predetermined position to said main body, said branch removal means provided to sever branches from a tree trunk.

In one embodiment, the branch removal means comprise cutting blades extending along said bridge portion. The blades extend outwardly along the inner edge of said bridge portion, and in another embodiment extend along both inner and outer edges of said bridge portion. In another embodiment, said inner edge blades extend continuously along said bridge portion and the first leg.

In yet another embodiment, branch removal means is attachably mounted on said main body, being a blade element attached to said bridge portion by means of an attachment bracket.

In still another embodiment, said hook element is attachably mounted to the distal end of said second leg by means of fastening element.

In yet another embodiment, the present invention comprises a main body with two legs, a handle formed at the end of a first leg, and branch removal means along the inner edge of the bridge between the two legs.

### THE OBJECT OF THE PRESENT INVENTION

The present invention eliminates the above disadvantages and provides an improved tool which can be used for both purposes: to manipulate the trunk of a tree and to cut all branches in an easy and simple manner.

This improved lumber hook could incorporate cutting elements integrated into the hook design itself, or by means of attaching such cutting element to any existing lumber hooks similar to those shown in prior art description.

The new invention allows to substantially shorten the time necessary to process all cut portions of fallen trees in an easy, fast, safe and simple operation.

### BRIEF DESCRIPTION OF DRAWINGS

FIG. 1 shows a perspective view of the first embodiment of the present invention.

FIG. 2 shows another perspective view of FIG. 1.

FIG. 3 shows a second embodiment of the present invention.

FIG. 3a shows a blade element of FIG. 3.

FIG. 4 shows a perspective view of the modification of the first embodiment shown on FIG. 1.

FIG. 4a shows s hook element of embodiment of FIG. 4.

### DETAILED DESCRIPTION OF THE PREFERRED EMBODIMENTS

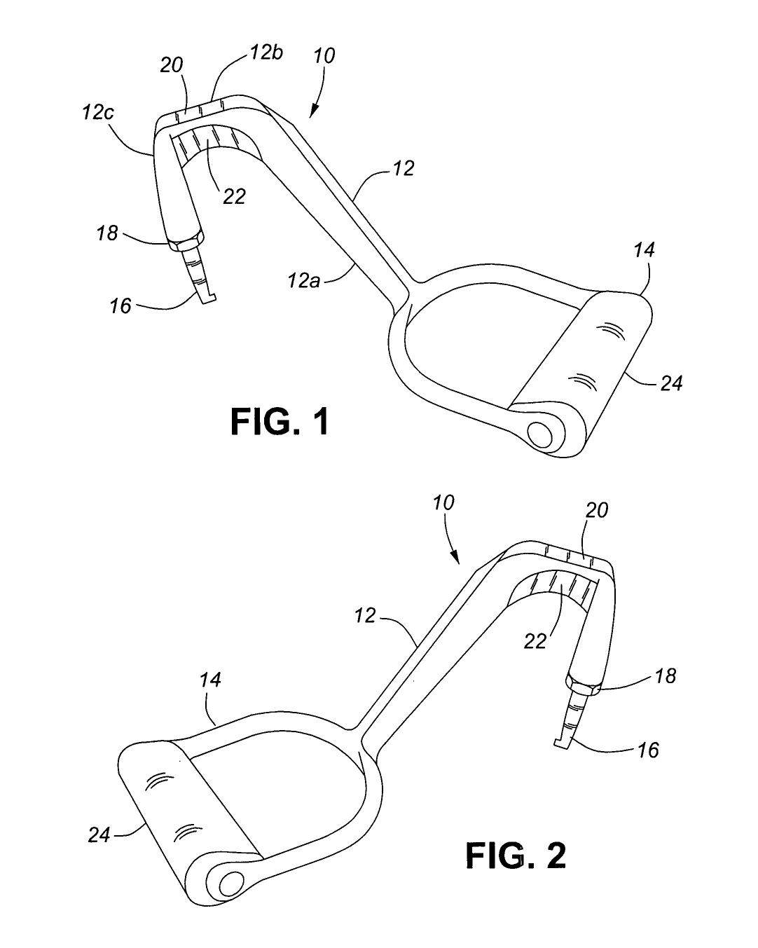

Referring to drawings, FIGS. 1 and 2 show a first embodiment of the present invention comprising a lumber hook 10 consisting of a main body 12 having substantially an inverted U-shaped configuration forming first and second legs 12a and 12c. First leg 12a and second leg 12c are inverted outwardly thus forming an open U configuration. A distal end of first leg 12a is connected to a handle 14 provided with a grabbing portion 24 having oval configuration. The other leg 12c has a hook element 16 extended from distal end of said leg 12c. Hook element 16 is attachably connected to the second leg 12c and may be replaced. Hook element 16 is mounted on leg 12c by means of fastener 18. The bridge portion 12b of the leg 12 has two blades 20 and 22 formed along outer and inner edges of said bridge portion 12b. Those blades 20 and 22 extend outwardly from said bridge portion and are designed to be used as axes to remove any branches from tree trunks intended for further processing. Blades 20 and 22 could be used by right-handed or left-handed persons and are sharp enough to remove small branches by simple downward force movement. To cut the branches, a user can swing the hook either palm down or in a backhanded motion. In use, 75% of the cutting is performed palm down and 25% using a backhand motion. The fact that blades 20 and 22 are mounted on both sides of the bridge portion 12b allows the user's choice of motion.

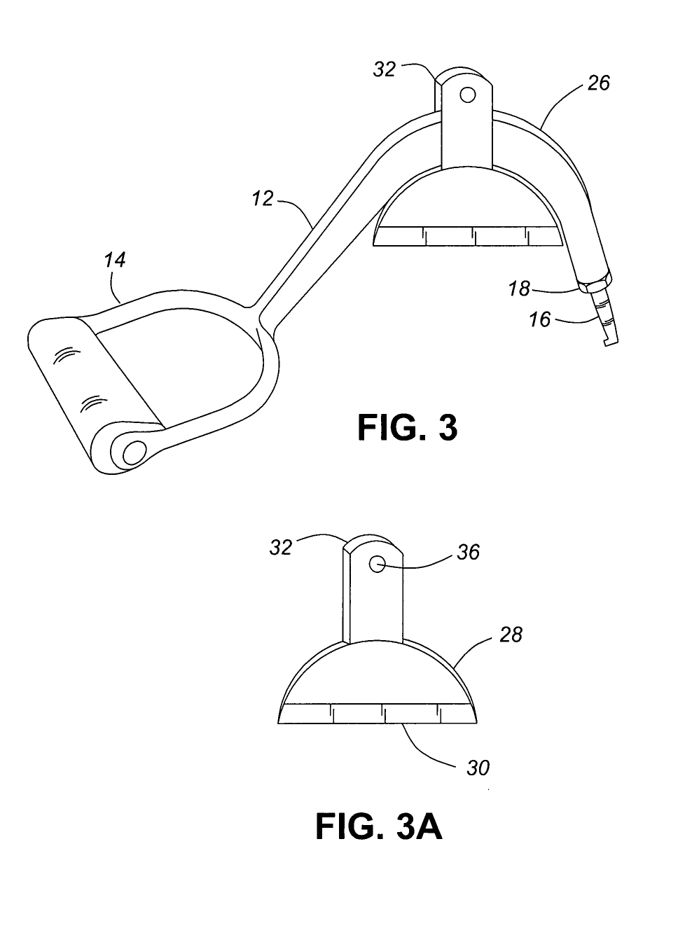

FIGS. 3 and 3a show a second embodiment of the present invention wherein a blade element 28 having a blade 30 and an attachment bracket 32 is mounted on any known hook, such as shown in U.S. Pat. Nos. 1,710,575 or 3,310,331. Blade element 28 is mounted on a bend portion of the hook between the hook portion and the handle portions by means of bracket 32 and screw 36. Again, the blade element of the present invention can be mounted for a right-handed or left-handed person.

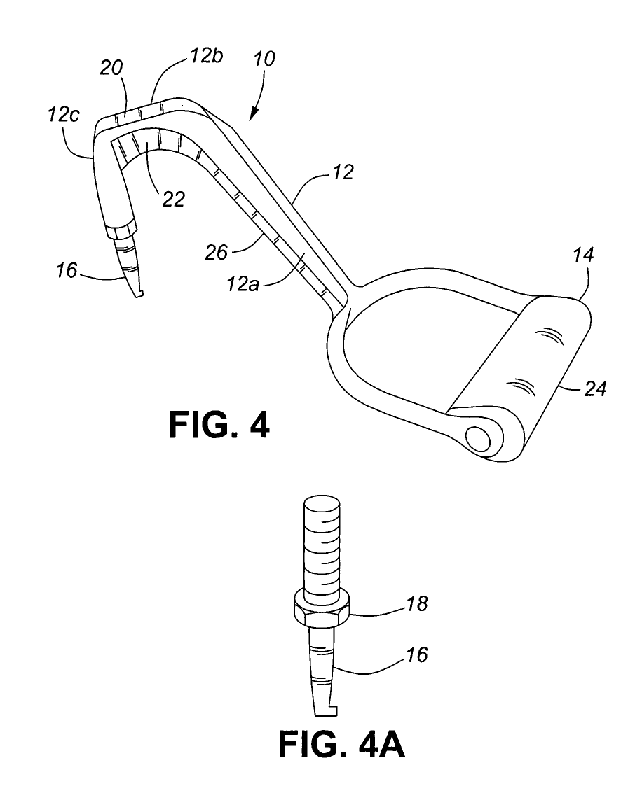

FIGS. 4 and 4a show a modification of the embodiment of FIG. 1, wherein blade 26 is formed along the inner edge of main body 10 and extends continuously to the distal end of the first leg 12a. Such modification allows to further increase the efficiency of the log hook of the present invention allowing using all length of first leg 12a.

The advantage of this modification stems from the fact that longer blade 26 improves chopping ability of the user, allowing the lumberjack to slice off some of the more stubborn branches rather than chop away at them. The longer blade 26 in this modification serves the function of machete or knife rather than axe in the slicing mode. This longer blade 26 increases efficiency by between 25% and 35% over the original embodiment.

In operation, the lumberjack first manipulates a trunk of the tree from the pile of wood, and then by simple motion he shaves off all branches one by one in a matter of a few minutes. Then, the same hook is used to manipulate the shaved trunk to any other desired position, such as loading onto a truck for transport.

The present invention has the following advantages:
it saves substantial amounts of time (at least one hour of labor per day);
it is easy to manipulate;
it is very compact and combines a hook and an axe;
it is easy to train any lumberjack to use it;
it can be attached to any traditional hook;
it is cheap and simple to manufacture;

In tests, once a lumberjack used this invention, he did not want to revert to a simple hook.

Thus, it can be seen that the objects of the present invention have been satisfied by the structure presented hereinabove. While in accordance with the Patent Statutes, only the best mode and preferred embodiments of the present invention have been presented and described in detail, it is to be understood that the invention is not limited thereto or thereby.

1. A log hook comprising:
a main body, said main body having a substantially inverted U-shape configuration forming two legs,
a first leg having a handle formed at distal end of said first leg;
a second leg having a hook element extending from a distal end of said second leg;
a bridge portion formed between adjacent ends of said first and second legs;
wherein said main body is provided with a branch removal means attached at a predetermined position to said main body, said branch removal means are provided to sever branches from a tree trunk, and
wherein said branch removal means extend outwardly along an outer and inner edge of said bridge portion.

2. Log hook according to claim 1, wherein said branch removal means comprise cutting blades.

3. Log hook according to claim 2, wherein said blades extend along said bridge portion.

4. Log hook according to claim 3, wherein said blades extend outwardly along an outer and an inner edge of said bridge portion.

5. Log hook according to claim 2, wherein said inner edge blades extend continuously along said bridge portion and said first leg.

6. Log hook according to claim 1, wherein said branch removal means is attachably mounted on said main body.

7. Log hook according to claim 6, wherein said branch removal means is a blade element attached to said bridge portion by means of an attachment bracket.

8. Log hook according to claim 1, wherein said hook element is attachably mounted to said distal end of said second leg.

9. Log hook according to claim 8, wherein hook element is attached to said second leg by means of fastening element.

10. A log hook comprising:
a main body, said main body having a substantially inverted U-shape configuration forming two legs,
a first leg having a handle formed at distal end of said first leg;
a second leg having a hook element extending from a distal end of said second leg;
a bridge portion formed between adjacent ends of said first and second legs;
wherein said main body is provided with a branch removal means attached at a predetermined position to said main body, said branch removal means are provided to sever branches from a tree trunk;
wherein said branch removal means comprise cutting blades, and
wherein said blades extend outwardly along an inner edge of said bridge portion.

11. Log hook according to claim 10, wherein said blades extend along said bridge portion.

12. Log hook according to claim 11, wherein said blades extend outwardly along an outer edge of said bridge portion.

13. Log hook according to claim 11, wherein said blades extend outwardly along an inner edge of said bridge portion.

14. Log hook according to claim 10, wherein said blades extend outwardly along an inner and outer edges of said bridge portion.

15. Log hook according to claim 10, wherein said inner edge blades extend continuously along said bridge portion and said first leg.

16. Log hook according to claim 10, wherein said branch removal means is attachably mounted on said main body.

17. Log hook according to claim 16, wherein said branch removal means is a blade element attached to said bridge portion by means of an attachment bracket.

18. Log hook according to claim 10, wherein said hook element is attachably mounted to said distal end of said second leg.

19. Log hook according to claim 18, wherein hook element is attached to said second leg by means of fastening element.

20. A lumber tool comprising:
a main body, said main body having a substantially inverted U-shape configuration forming two legs,
a first leg having a handle formed at distal end of said first leg;
a second leg;
a bridge portion formed between adjacent ends of said first and second legs;
wherein said main body is provided with a branch removal means attached at a predetermined position to said main body, said branch removal means are provided to sever branches from a tree trunk;
wherein said branch removal means comprise cutting blades, and
wherein said blades extend outwardly alone an inner edge of said bridge portion.

21. A lumber tool according to claim 20, wherein said blades extend outwardly along an inner edge of said bridge portion.
